(19) United States
(12) Patent Application Publication
(10) Pub. No.: US 2009/0135741 A1
(43) Pub. Date: May 28, 2009

(54) Regulated voice conferencing with optional distributed speech-to-text recognition

(75) Inventors: Myroslav Mykhalchuk, Lviv (UA); Denys Spektor, Lviv (UA); Yuriy Mykhalchuk, Rohatyn (UA); Dmytro Petrov, Lviv (UA)

Correspondence Address: MORGAN LEWIS & BOCKIUS LLP, 1111 PENNSYLVANIA AVENUE NW, WASHINGTON, DC, 20004, US

(73) Assignee: Say2Go, Inc.

(21) Appl. No.: 12/292,859

(22) Filed: Nov. 26, 2008

Related U.S. Application Data
(60) Provisional application No. 60/990,910, filed on Nov. 28, 2007.

(51) Int. Cl. H04L 12/16; G10L 15/26

(52) U.S. Cl. 370/260; 704/235

(57) ABSTRACT

Systems and methods for regulated voice conferencing are provided. A system for regulated voice conferencing includes multiple communication devices connected to a network. The communications devices are operative to receive audio inputs from and deliver audio outputs to users of the devices to conduct a regulated, voice conference using a half-duplex communication mode. Each communication device includes a messenger application and a speech-to-text recognition (STTR) application. The messenger application is operative to capture the audio inputs, encode the audio inputs, and transmit the encoded audio inputs over a network, and to receive encoded audio inputs over the network and convert the received encoded audio inputs to the audio outputs. The STTR application is operative to convert the audio signals into text signals corresponding to the audio signals, to transmit the text signals over the network, and to receive text signals over the network.

### CROSS-REFERENCE TO RELATED APPLICATIONS

This application claims the benefit of priority under 35 U.S.C. § 119(e) to U.S. Provisional Application No. 60/990,910, filed on Nov. 27, 2007, the disclosure of which is incorporated by reference herein in its entirety. This application further claims the benefit of priority under 35 U.S.C. § 120 to U.S. application Ser. No. 12/120,926, filed on May 15, 2008, the disclosure of which is incorporated by reference herein in its entirety.

### BACKGROUND OF THE INVENTION

1. Field of the Invention

The present invention is related generally to network communications systems and, more particularly, to voice communication over computer networks.

2. Background of the Related Art

Voice communication over computer networks is increasingly popular. When transferred over the Internet, voice-over-IP (VoIP) technology is widely used. Without limitation, voice communication between two or more people over computer networks is hereinafter referred to as “conference” or “conferencing”, and communicating people are hereinafter referred to as “conference participants” or “participants”. At present, voice communication over computer networks is mainly duplex, i.e., voices of all parties to the conference are transmitted into the conversation at the same time. It often causes problems with the quality of the conference when, e.g. two people start talking simultaneously, or noise is being transmitted from a party not presently speaking, or echo occurs due to the sound picked up by parties' microphones and then submitted back into the conversation. This mode closely emulates talking over a regular telephone. The above drawbacks can be mitigated by implementing half-duplex mode in voice communication over computer networks, which would also by its nature support dialog-based communication. As well, presently widespread full-duplex mode of voice conferencing has drawbacks of:
a. lacking capability of textual search through the voice communication history which would be particularly important in business conferencing
b. technically complicating automated speech-to-text recognition (STTR) which would be a remedy to the above. At present level of technology, automated STTR technologies require that the system be trained to specifics of a speaker's voice, used hardware, and acoustics for maximum accuracy. When two or more voices overlap or a voice overlaps with a noise coming from another user's microphone, the STTR system critically loses accuracy.

Therefore, in appreciation of people's desires to 1) communicate over computer networks in voice in dialogue-based manner and 2) have their conversations seamlessly registered in textual history for future search and reference, it can be appreciated that there is a significant need for a system and method that will provide half-duplex voice conferencing optionally coupled with an efficient STTR system. Further, it is known that STTR is a computationally intensive task so high-accuracy recognition of multiple voice conferences on a server is an overly complicated technical task. (E.g., popular VoIP application Skype commercially available from Skype Limited consistently shows 8 to 10 million users who are concurrently online and many of these users are talking to each other in voice at any given moment. It's presently unfeasible to build a server able to recognize these voice conversations into text with high quality within reasonable time.)

Therefore it can be further appreciated that there is a significant need in STTR approach where the task of recognizing speech of two or more conference participants is distributed among these users' computers which normally have lots of computing power to spare most of the time. Each user's computer can recognize speech of its user, optionally applying the pre-trained user's profile to maximize recognition accuracy, and then the recognized results are automatically gathered into integrated conference history and distributed to all conference participants by messaging server. The present invention provides these and other advantages, as will be apparent from the following detailed description and accompanying figures.

### SUMMARY OF THE INVENTION

The system preferably includes a multiplicity of communications devices connectable to a computer network via a multiplicity of connection media which may either be wired or wireless. It will be appreciated by those skilled in the art that communications device can be any device operative to interface with a preferably human user and execute computer instructions such as a software or firmware program, including but not limited to a PC, a computer other than PC, a portable computer, a hand-held device, a programmable consumer electronic device, a network PC, or a web application executable platform-independently in a Web browser.

Communications devices are preferably operative to receive inputs, including audio inputs via built-in or standalone devices from and deliver outputs, including audio outputs via built-in or standalone audio reproducing devices, to users. As well, communications devices are preferably operative to transmit and receive information via computer network to and from at least one server which is also connected to computer network via connection media. Server is likewise operative to send and receive information via computer network.

A messenger apparatus, which is typically resident in communications device, in a preferred embodiment of the present invention connects to a messaging server, which is typically resident in at least one server and in one embodiment of the present invention implements and extends Jabber set of open instant messaging protocols. A multiplicity of messengers is connectable to at least one messaging server thus fulfilling common messaging functions such as user authorization, maintaining lists of sought users known as “buddy lists”, exchanging presence information, and the like.

Additionally, two or more users each running their messengers can engage in a normal voice communication in the form of dialog-based discussion, e.g. to fulfill a business or leisure conference call. Any user can activate voice a transfer function in his/her messenger by a configurable action, such as pressing and holding a designated button or toggling this button to initiate voice transfer and then toggling it again to complete the voice transfer. The messenger of speaking user captures his/her voice and transfers it to messengers of listening users. According to one embodiment of the invention, the messenger is operative to capture and transmit voice to other messengers, preferably bypassing the messaging server using so called peer-to-peer mode. These transmissions are typically implemented using network streaming technologies. The messaging server controls the multiplicity of messengers engaged in any given conference to facilitate a convenient dialog based conversation, in particular so that:
a. there is only one user transmitting his/her voice into the conference at any given time;
b. there is one user in any given conference who is deemed a moderator and who can override other users' messengers transmitting into the conference; and/or
c. all messengers engaged in the conversation display information to their respective users about the possibility of starting the voice transmission into the conference at this given moment, the identity of currently speaking user, optionally a list of other users waiting in the queue, etc.

Additionally, an embodiment of the present invention includes speech-to-text recognition (STTR) applications which are typically resident in each communications device and are operative to recognize the speech of messenger users. Personal STTR applications are now widely available for modern communications devices, e.g. installed on PCs within Microsoft Windows Vista or freely downloadable for other versions of Microsoft Windows, all commercially available from Microsoft Corporation. The speech-to-text recognition application is operative to take audio inputs from a built-in or standalone device such as microphone, optionally using a prerecorded profile of the sender for enhancing the recognition accuracy, and to return recognized text to the messaging server. The messaging server may then transmit the recognized text to messengers used by the sender and the intended recipients of the voice message. Recognized text is preserved in a messaging history file, coupled with original voice recordings, thus enabling textual search through the history of the voice messaging. The history is preferably stored in a communications device where the related messenger is typically resident. In another embodiment of the present invention, the history is stored in a server.

Further, in an embodiment of the present invention, the speech-to-text recognition application is operative to capture and preserve the profile of each user and apply this profile to enhance quality of speech-to-text recognition of further voice messages sent by the particular user.

It will be appreciated by those skilled in the art that the stated method of using STTR at communication devices of voice conference participants with subsequent combining of recognized text transcripts of each user's voice messages into an integrated transcript of the voice conference, rather than performing STTR function at a server, is a standalone innovation which can be applied to any voice conference done with the help of communication devices, including but not limited to the regulated voice conferencing described herein as well as the common Voice-over-IP calling implemented by a number of applications available on the market today.

It will be appreciated by those skilled in the art that in other embodiments of the present invention most or all of the employed functions of servers may be replaced by functions built into communications devices and messengers, thus implementing server-less peer-to-peer communication.

### BRIEF DESCRIPTION OF THE DRAWINGS

FIG. 1 is a simplified diagram of a system that includes components to implement an embodiment of the present invention.

FIG. 2 is a simplified flowchart illustrating the operation of significant functions in an embodiment of the present invention.

FIG. 3 is a simplified flowchart illustrating how the speaking sequence of conference participants may be regulated and the special role of conference moderator in an embodiment of the present invention.

### DETAILED DESCRIPTION OF PREFERRED EMBODIMENTS

As described herein, a network system for voice communication over computer network implements speech-to-text recognition (hereafter STTR) at users' communication devices, such as PCs running Microsoft Windows with installed Microsoft STTR engines commercially available from Microsoft Corporation. The network system may use network streaming to transmit voice messages to one or more servers or, in peer-to-peer mode, directly to other users' messengers.

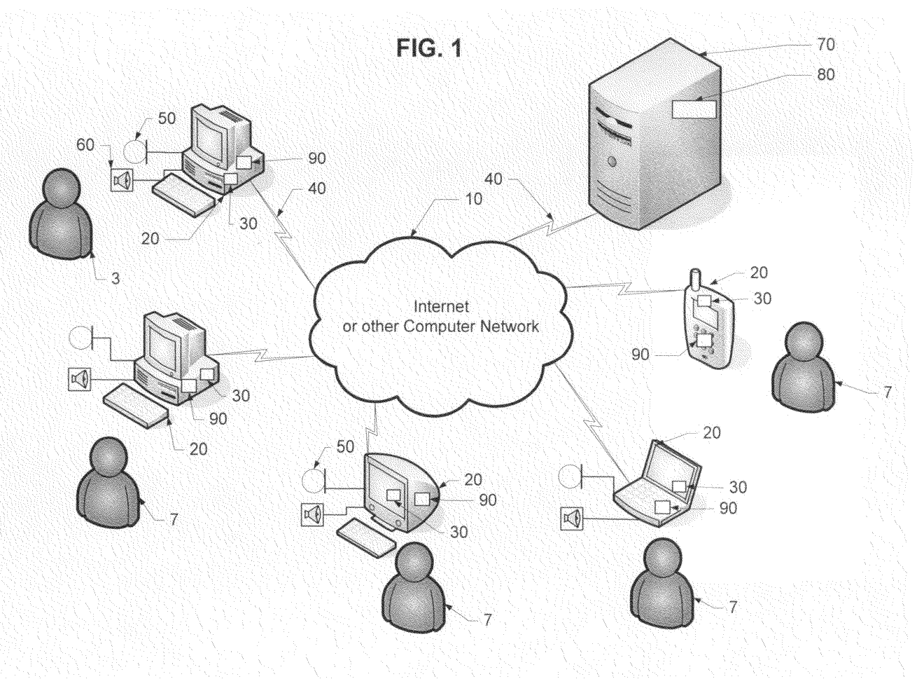

Reference is now made to FIG. 1 which is a simplified pictorial illustration of a system that includes components to implement a preferred embodiment of the present invention.

The system preferably includes multiple communications devices 20, connectable to a computer network 10 via a multiple of connection media 40 which may either be wired or wireless. It will be appreciated by those skilled in the art that communications device 20 can be any device operative to interface with a preferably human user and execute computer instructions such as a software or firmware program, including but not limited to a PC, a computer other than PC, a portable computer, a hand-held device, a programmable consumer electronic device, a network PC, or a web application executable platform-independently in a Web browser. The invention may also be practiced in distributed computing environments where tasks are performed by remote processing devices that are linked through a communications network. In a distributed computing environment, program modules may be located in both local and remote memory storage devices.

Communications devices 20 are preferably operative to receive inputs, including audio inputs via built-in or standalone devices such as microphones 50, from and deliver outputs, including audio outputs via built-in or standalone audio reproducing devices 60, to users such as 3 or 7. As well, communications devices 20 are preferably operative to transmit and receive information via computer network 10 to and from at least one server 70 which is also connected to computer network 10 via connection media 40. Server 70 is likewise operative to send and receive information via computer network 10.

A messenger apparatus 30, which is typically resident in communications device 20, in a preferred embodiment of the present invention connects to a messaging server 80, which is typically resident in at least one server 70 and in one embodiment of the present invention implements and extends the Jabber set of open instant messaging protocols. Multiple messengers 30 are connectable to at least one messaging server 80 thus fulfilling common messaging functions such as user authorization, maintaining lists of sought users known as “buddy lists”, exchanging presence information, and the like.

Additionally, two or more users each running their messengers 30 can engage into a normal voice communication in the form of dialog-based discussion, e.g. to fulfill a business or leisure conference call. Any user 3 can activate voice transfer function in his/her messenger by a configurable action such as pressing and holding a designated button or toggling this button to initiate voice transfer and then toggling it again to complete the voice transfer. Messenger 30 of speaking user 3 captures his/her voice and transfers it to messengers 30 of listening users 7. For the purposes of this invention, messenger 30 is operative to capture and transmit voice to other messengers 30, preferably bypassing messaging server 80 using so called peer-to-peer mode. These transmissions are typically implemented with the use of network streaming technologies. Messaging server 80 controls the messengers 30 engaged in any given conference to facilitate a convenient dialog based conversation, in particular that:
1. there is only one user such as 3 or 7 transmitting his/her voice into the conference at any given time;
2. there is one user in any given conference who is deemed a moderator and who can override other users' messengers transmitting into the conference; and/or
3. all messengers 30 engaged in the conversation display information to their respective users 3, 7 about possibility of starting the voice transmission into the conference at this given moment, the identity of currently speaking user such as 3, optionally a list of other users such as 7 waiting in the queue, etc.

Additionally, a preferred embodiment of the present invention includes speech-to-text recognition (STTR) applications 90 resident in each communications device 20 and operative to recognize the speech of messenger users. Personal STTR applications 90 are now widely available for modern communications devices, e.g. installed on PCs within Microsoft Windows Vista or freely downloadable for other versions of Microsoft Windows, all commercially available from Microsoft Corporation. Speech-to-text recognition application 90 is operative to take audio inputs from built-in or standalone devices such as microphone 50, optionally using a prerecorded profile of the sender for enhancing the recognition accuracy, and to return recognized text to messaging server 80. Messaging server 80 then transmits recognized text to messengers 30 used by the sender and the intended recipients, such as 3 or 7, of the voice message. Recognized text is preserved in a messaging history that may be coupled with original voice recordings, thus enabling textual search through the voice messaging history. The history is preferably stored in communications device 20 where the related messenger 30 is typically resident. In another embodiment of the present invention, the history is stored in server 70.

Further, in a preferred embodiment of the present invention, speech-to-text recognition application 90 is operative to capture and preserve the profile of each user such as message sender 3, and apply this profile to enhance quality of speech-to-text recognition of further voice messages sent by this user.

It will be appreciated by those skilled in the art that in another embodiment of the present invention most or all of the employed functions of servers 70 and 80 may be replaced by functions built into communications devices 20 and messengers 30, thus implementing server-less peer-to-peer communication.

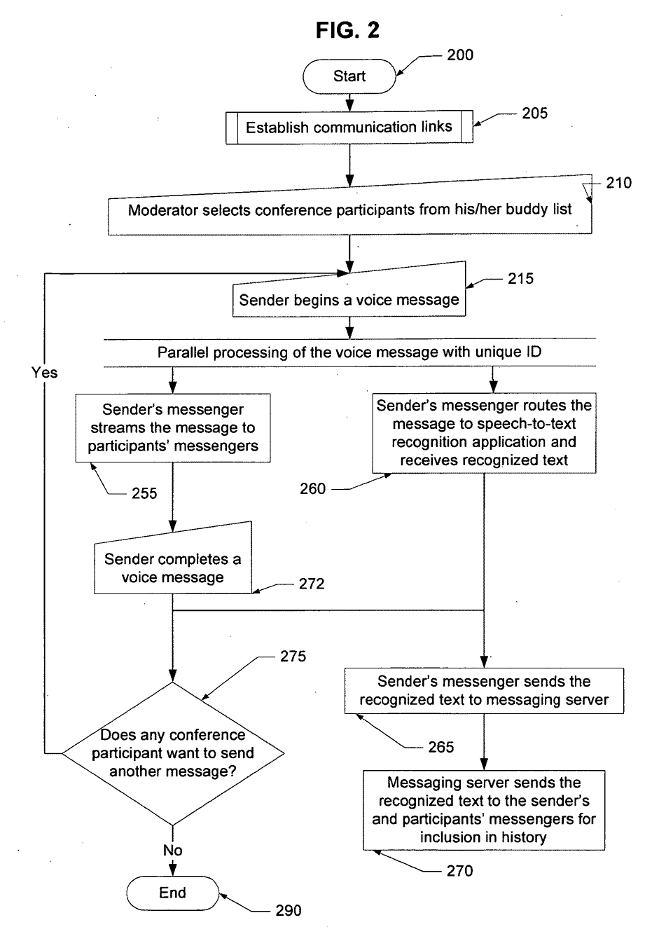

Reference is now made to FIG. 2 which is a simplified flowchart illustrating the operation of significant functions in an embodiment of the present invention. As well, references to components shown in FIG. 1 continue to be used hereinafter. At a start 200, it is assumed that multiple users wish to engage in a messaging communication session. In step 205, links are established between participants and the servers. The process of establishing the messaging communication links between participants via the computer network 10 such as the Internet is well-known and need not be described herein.

In step 210, user such as 3 who initiates a regulated conference call session (hereinafter referred to as the moderator), selects at least one of the users, e.g., from his/her buddy list, in messenger 30 as participant(s) to a regulated conference call session (hereinafter referred to as conference). Users need to confirm their willingness to join the conference prior to being added.

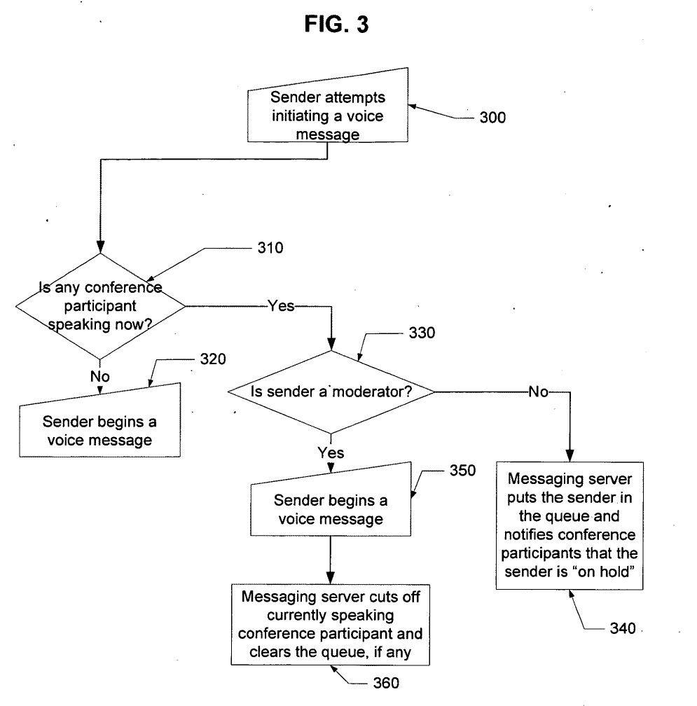

In step 215, a sender such as user 3 attempts initiating his/her voice message via configurable action and, when granted the right to talk by messaging server 80, begins narrating his/her voice message (process of regulating the sequence of conference participants' talking by messaging server is described in detail in FIG. 3 and related description hereafter). In a preferred embodiment of the present invention, the sender presses and holds a configurable button on the communications device 20 to initiate the voice streaming session (or presses and quickly releases the button to toggle streaming on), and then says a message into audio input device such as microphone 50. If communications device 20 is a computer, the configurable button can be Space button on the keyboard or a button on a pointing device. In another embodiment of present invention, the sender initiates the voice streaming session by starting to speak while messenger 30 monitors microphone 50 to define the sender's intent to initiate the voice streaming session. Upon initiating the voice streaming session, messenger 30 assigns the voice message which is being streamed with a unique identification number (hereinafter referred to as ID) and communicates this ID to messaging server 80 along with the notification about the sender streaming the message to the selected set of conference participants, such as 7.

In step 255, messenger 30 starts streaming the voice message dictated by the sender to messengers 30 of the selected set of conference participants such as 7.

Simultaneously, in step 260, messenger 30 starts routing the voice message dictated by the sender to STTR application 90. In one embodiment of the present invention, STTR application 90 resides on the same communications device 20 as messenger 30 of each conference participant. If communications device is a PC running Microsoft Windows operating system then speech-to-text recognition application can be Microsoft speech recognition engine shipped with Windows or available for download for Windows users, all commercially available from Microsoft Corporation. In this case messenger 30 invokes speech-to-text recognition application 90 which takes audio input from microphone 50, optionally using a prerecorded profile of the sender for enhancing the recognition accuracy, and returns recognized text to messenger 30. In another embodiment of the present embodiment, speech-to-text recognition application 90 can reside on a server or a cluster of servers (not shown).

When the message is over, the sender releases the configurable button (or presses and quickly releases it to toggle streaming off) in step 272, thus acting similarly to Push-To-Talk systems.

In step 265, sender's messenger 30 having received complete recognized text from speech-to-text recognition application 90 passes the recognized text to messaging server 80 along with the unique message ID.

In step 270, messaging server 80 sends the recognized text to messengers 30 of the sender and the same set of conference participants as in step 255, to be included in text history preserved in messengers 30, optionally along with history of voice messages.

In step 270 messaging server 80 checks if any of conference participants is in the queue (detailed in FIG. 3). If the queue is empty, then messaging server 80 awaits for any conference participant to initiate a voice message. If all conference participants choose to leave the conferencing session, it is deemed closed.

Reference is now made to FIG. 3 which is a simplified flowchart illustrating the regulation of speaking sequence of conference participants and the special role of conference moderator in a preferred embodiment of the present invention. As well, references to components shown in FIG. 1 and FIG. 2 continue to be used hereinafter.

In step 300, a sender such as user 3 attempts to initiate his/her voice message. In a preferred embodiment of the present invention, the sender presses and holds a configurable button on the communications device 20 (or presses and quickly releases the button to toggle streaming on) to indicate to messaging server 80 that he/she intends to initiate the voice streaming session. In another embodiment of present invention, the sender indicates to messaging server 80 that he/she intends to initiate the voice streaming session by starting speaking while messenger 30 monitors microphone 50 to define the sender's intent to initiate the voice streaming session.

In step 310, messaging server 80 verifies whether any other conference participant is speaking now. In no, then in step 320 messaging server 80 grants a sender the right to initiate the voice streaming session and narrate his/her voice message.

If yes in step 310, then in step 330 messaging server 80 verifies whether the user who attempts initiating his/her voice message is the moderator of the regulated conference call session. If no, then in step 340 messaging server 80 puts the user in the queue and notifies conference participants that this user is “on hold”.

If yes in step 330, then in step 350 messaging server 80 allows the user to begin a voice streaming session. Simultaneously, in step 360 messaging server 80 cuts off the voice streaming session by any presently speaking conference participant and clears the queue, if any. It will be appreciated by those skilled in the art that, without any limitation to the described system and method for regulated voice conferencing which is the subject of present invention, the described system is also capable of implementing regular textual “voice conferencing”.

It will be appreciated by those skilled in the art that, without any limitation to the described system and method for regulated voice conferencing using a half-duplex mode of communication which is the subject of present invention, the described system is also capable of implementing regular textual “instant messaging”. Even though not required for voice communication, an embodiment of the present invention includes regulated textual “instant messaging” to provide for “all-in-one” messaging experience for its users.

It is appreciated that any of the software components of the present invention may, generally, be implemented in firmware or hardware, if desired, using conventional techniques.

It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination.

It will be appreciated by persons skilled in the art that the present invention is not limited to the specific features shown and described hereinabove. It will be apparent to those in the art that various modifications can be made without departing from the scope of the inventions described. Accordingly, it is intended that that present invention not be limited to the described embodiments, but that it has the full scope defined by the claims, and equivalents thereof.

What is claimed is:

1. A system for regulated voice conferencing comprising:
multiple communication devices, wherein said communication devices connect to a network and are operative to receive audio inputs from and deliver audio outputs to users of said devices to conduct a regulated, voice conference using a half-duplex communication mode;
each said communication device including a messenger application and a speech-to-text recognition (STTR) application,
wherein said messenger application is operative to capture said audio inputs, encode the audio inputs, and transmit the encoded audio inputs over a network, and to receive encoded audio inputs over the network and convert the received encoded audio inputs to the audio outputs; and
wherein said STTR application is operative to convert the audio signals into text signals corresponding to the audio signals, to transmit the text signals over the network, and to receive text signals over the network.

2. The system of claim 1, wherein said audio inputs and said audio outputs include voice messages.

3. The system of claim 2, wherein the communication devices transmit said voice messages using network streaming.

4. The system of claim 1, further comprising at least one server, wherein said server is connected to said network and regulates the voice conference among the communications devices.

5. The system of claim 4, wherein said server allows only one said communication device to transmit said audio inputs into the voice conference at any given time.

6. The system of claim 5, wherein said server allows one communication device to be deemed a moderator of said voice conference.

7. The system of claim 1, wherein said communication devices engaged in the voice conference display information to their respective users, and
wherein said information includes at least one of a possibility of starting a voice transmission, an identity of said user currently speaking, and a list of other said users waiting in a queue to transmit.

8. The system of claim 1, wherein at least one of said STTR applications uses the user's prerecorded voice profile in converting the audio inputs to the text signals.

9. The system of claim 2 wherein said text signals are correlated with said voice message.

10. A method for conducting a regulated voice conference, comprising:
a) capturing at least one voice message of a user using a communication device;
b) assigning said voice message a unique identification number;
c) linking the communication device to a communication device of at least one voice conference participant via a network, the at least one voice conference participant selected from a buddy list of multiple of users stored in the user's communication device; and
d) transmitting said voice message and said unique identification number from the user's communication device to the participant's communication device.

11. The method of claim 10, wherein step (d) comprises streaming said voice message from said user's communication device to the participant's communication device.

12. The method of claim 11, further comprising translating said voice message into text and transmitting the text via the network.

13. The system of claim 12, wherein said step of translating comprises using a prerecorded voice profile.

14. The method of claim 12, wherein said text is coupled with said voice message such that the content of said voice message can be identified through a search of said text.

15. The method of claim 12, wherein step (d) comprises linking said user's communication device to a voice conferencing server via the network.

16. The method of claim 15, further comprising transmitting said text from said user's communication device to said server.

17. The method of claim 10, further comprising displaying a waiting queue of one or more voice conference participants who want to transmit a voice message.

18. A method for conducting a regulated voice conference, comprising:
a) linking a user's communication device to a communication device of at least one voice conference participant via a network, the at least one voice conference participant selected from a buddy list of multiple of users stored in the user's communication device;
b) capturing voice messages and transmitting captured voice messages to the communication device of the at least one conference participant and receiving voice messages from the communication device of the at least one participant to thereby conduct a voice conference using a half-duplex communication mode; and
c) converting the captured voice messages into text and transmitting the text via the network.

19. The method for conducting a regulated voice conference according to claim 18, further comprising associating the text with the captured voice messages.

20. The method for conducting a regulated voice conference according to claim 19, further comprising receiving text of the received voice messages.

21. The method for conducting a regulated voice conference according to claim 20, further comprising associating the text of the captured voice messages and the received text to form a transcript of the voice conference.

22. Apparatus for conducting a voice conference over a computer network, comprising:
a communication device having a microphone for converting a user's voice into voice input signals and a speaker for converting received voice signals into an audible voice to effect a voice conference in a half-duplex communication mode, wherein said communication device further includes a messenger application and a speech-to-text recognition (STTR) application,
wherein said messenger application is operative to encode the voice input signals and transmit the encoded voice input signals over a network, and to receive encoded voice signals over the network, convert the received encoded voice signals to the received voice signals, and apply the received voice signals to the speaker; and
wherein said STTR application is operative to convert the voice input signals into text signals corresponding to the voice input signals, to transmit the text signals over the network, and to receive text signals over the network, the received text signals corresponding to a text version of the received voice signals.

23. The apparatus of claim 22, further comprising associating the text signals with the voice input signals.

24. The apparatus of claim 22, further comprising associating the text signals of the voice input signals and the received text signals to form a transcript of the voice conference.

25. A method for regulating a half-duplex voice conference among users of communication devices through a computer network, comprising:
establishing communication links over a computer network with a first communication device and at least a second communication device, wherein the first and second communication devices facilitate a voice conference in a half-duplex communication mode;
receiving a first data stream from the first communication device, the first data stream including data representing voice signals input by a user of the first communication device;
receiving a second data stream from the first communication device, the second data stream including data representing text of the voice signal input by the user;
associating the first and second data streams;
transmitting a third data stream to the second communication device through the computer network, the third data stream including data representing the voice signals input by the user; and
transmitting a fourth data stream to at least one of the first and second communication devices, the fourth data stream including data representing the text voice signal.

26. The method of claim 25, wherein said method is performed by a server.

27. The method of claim 25, further comprising associating the first and second data stream with the user of the first communication device.

28. The method of claim 27, further comprising storing a text and audio transcript of the voice conference.

29. The method of claim 25, further comprising transmitting to at least the first and second communication devices data representing a queue of users who wish to transmit audio signals.

30. A method for managing a voice conference among users of communication devices through a computer network, comprising:
establishing communication links over a computer network with multiple communication devices to facilitate a voice conference in a half-duplex communication mode among the communications devices.

31. The method of claim 30, further comprising regulating a sequence of communications of the voice conference.

32. A method for conducting a voice conference among users of communication devices, comprising:
receiving data streams from the communication devices, the data streams including data representing voice signals input by the users of the communication devices and data representing text generated via speech-to-text recognition of the voice signals at the users' communication devices; and
associating the data from the received data streams to assemble a text transcript of the voice conference.

33. The method of claim 32, wherein the step of associating comprises associating the voice signals and the text of the voice signals to form a combined transcript.
